(19) United States
(12) Patent Application Publication
(10) Pub. No.: US 2003/0075969 A1
(43) Pub. Date: Apr. 24, 2003

(54) Industrial truck with a safety belt

(76) Inventors: Georg Fromme, Hamburg (DE); Willi Hilgers, Plietzhausen (DE)

Correspondence Address: WEBB ZIESENHEIM LOGSDON, ORKIN & HANSON, P.C., 700 Koppers Building, 436 Seventh Avenue, Pittsburgh, PA, 15219-1818, US

(21) Appl. No.: 10/251,617

(22) Filed: Sep. 20, 2002

(30) Foreign Application Priority Data
Sep. 21, 2001 (DE) 101 46 627.7

(51) Int. Cl. B60R 22/48

(52) U.S. Cl. 297/468

(57) ABSTRACT

The invention provides an industrial truck with a driver's seat (1) and a safety belt (2). The safety belt (2) has a belt buckle and a belt buckle sensor (7) that detects the status of the belt buckle. The belt buckle sensor (7) is connected with a control unit (11). A presence sensor (8) is connected with the control unit (11) and detects the presence of a person in the driver's seat. The control unit (11) is realized so that the status and/or changes in the signals generated by the belt buckle sensor (7) and the presence sensor (8) are continuously monitored and evaluated in the control unit (11). The control unit (11) has at least one signal output (12) which reports the proper or improper use of the safety belt (2) as a function of the result of the evaluation of the signals.

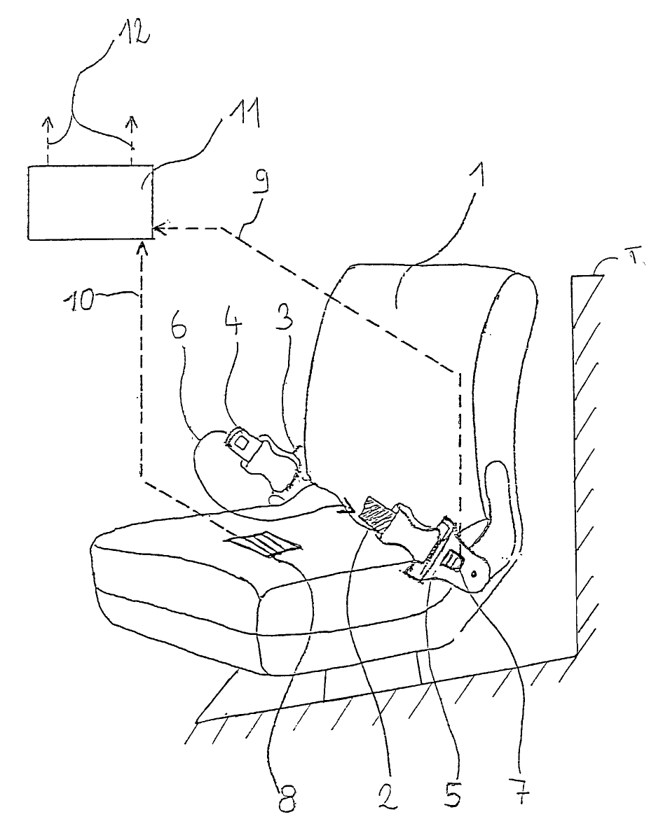

### CROSS REFERENCE TO RELATED APPLICATION

This application corresponds to German Application No. 101 46 627.7 filed Sep. 21, 2001, which is herein incorporated by reference in its entirety.

### BACKGROUND OF THE INVENTION

1. Field of the Invention

This invention relates to an industrial truck with a driver's seat and a safety belt associated with the driver's seat, which safety belt has a belt buckle and a belt buckle sensor that detects the status of the belt buckle, with the belt buckle sensor effectively connected with a control unit of the industrial truck.

2. Technical Considerations

Industrial trucks with a driver's seat and, in particular, fork-lift trucks are generally equipped with a safety belt in the form of a lap belt. The purpose of the safety belt is to hold the operator of the industrial truck in the driver's seat during accident situations. A particularly dangerous accident situation is the tipping of a fork-lift truck because there is a risk that the operator may fall out of the open driver's cab and then be pinned to the floor by parts of the driver's cab. The use of the safety belt can provide significant protection for the operator in this accident situation because the safety belt can securely prevent the operator from falling out of the driver's cab.

However, in spite of the presence of the safety belt and in violation of the applicable safety requirements, in actual practice the operators of industrial trucks frequently do not use the safety belt. The reason for not using the safety belt is that the operator finds it difficult and time-consuming to keep connecting and disconnecting the safety belt, especially if the operator is required to get out of the industrial truck repeatedly, such as in order picking operations, for example.

To give the operator an incentive to use the safety belt, the prior art describes systems in which the status of the buckle of the safety belt is monitored with a belt buckle sensor and, if necessary, an acoustical alarm or a warning light is actuated if the belt buckle is open during the operation of the industrial truck. However, this alarm or warning function is frequently deactivated by the operator of the industrial truck by inserting a duplicate of the belt buckle tab that is attached to the belt into the slot of the buckle that is located on the driver's seat, or by looping the belt around the back of the driver's seat and then closing the belt buckle.

Therefore, it is an object of the invention to provide an industrial truck in which the correct use of the safety belt can be securely monitored.

### SUMMARY OF THE INVENTION

The invention provides an industrial truck having a safety assembly including a presence sensor that detects the presence of a person in the driver's seat and is operationally connected with the control unit. In addition to monitoring the status of the belt buckle, the presence sensor also monitors whether a person is sitting in the driver's seat. By combining the signals from the presence sensor and the belt buckle in the control unit, it becomes possible to detect the misuse of the belt buckle.

The invention also provides a control unit configured such that the status of and/or changes in the signals generated by the belt buckle sensor and the presence sensor are continuously monitored and evaluated in the control unit. The proper use of the safety belt is, therefore, continuously monitored during the use of the industrial truck and, in particular, each time the operator boards and exits the truck.

The control unit can also have a signal output which reports the correct or incorrect use of the safety belt, depending on the result of the evaluation of the signals. By means of the signal output, and depending on whether the safety belt is being used correctly or incorrectly, acoustical or optical alarm devices, for example, can be activated, or certain functions of the industrial truck can be influenced. For example, the signal output can be realized in the form of physical output interfaces. It is, likewise, possible to realize the signal output in the form of an electrical conductor that is enclosed inside the control unit if the signal from the signal output is processed directly in the control unit.

In a first embodiment of the control unit of the invention, the presence sensor that indicates the presence of a person reports (e.g., generates an electrical signal) the correct use of the safety belt if the belt buckle sensor simultaneously signals that the belt buckle is closed. The system, therefore, monitors whether the belt buckle is closed when an operator is present.

Moreover, when there is a presence sensor that indicates that a person is getting up from the driver's seat, the proper use of the safety belt is reported by the signal output if, shortly prior to that, the belt buckle sensor has signaled the opening of the belt buckle. The system, therefore, monitors whether the belt buckle is opened before the operator gets up. If that is not the case, the control unit assumes that the belt buckle is being misused, e.g., that it has been closed using a duplicate belt buckle.

When there is a presence sensor that indicates that a person has sat down on the driver's seat, the signal output then reports the correct use of the safety belt if the belt buckle sensor simultaneously indicates an open belt buckle. The system thereby assumes that the operator can only sit down on the driver's seat if the buckle is open. If an operator nevertheless sits down, the control unit in turn assumes that the belt buckle is being used improperly.

The control unit can be advantageously realized so that short-term weight reductions indicated by the presence sensor can be disregarded during the evaluation. For example, if the truck travels over a bump or if the driver bends forward to look at something and thereby reduces the load on the driver's seat, this temporary reduction is tuned out by a suitable filter.

The control unit can be realized so that if the signal output reports improper use of the belt buckle, in particular the non-attachment of the safety belt, the traction operation of the industrial truck is blocked. It can thereby be guaranteed that the industrial truck can only be operated when the safety belt is being used correctly.

In an additional embodiment of the invention, the control unit can be realized so that when the signal output reports improper use of the safety belt and, in particular, when the safety belt is not attached, traction operation of the industrial truck is possible only at a reduced maximum speed.

The industrial truck can, therefore, be operated even when the safety belt is not attached, although only at speeds that are low enough that the tipping of the industrial truck can be securely prevented.

It is also possible to realize the control unit so that a continuous alarm signal is generated when the signal output indicates misuse of the safety belt, in particular, an attempt to defeat the safety features of the belt buckle. When the system detects that the belt buckle has been closed in an attempt to defeat the safety feature, it can, for example, after a certain delay period generate an acoustical alarm which can only be deactivated by specially authorized persons.

It is particularly appropriate if the control unit is realized so that the control parameters can be set and different methods can be used to evaluate the signals from the belt buckle sensor and the presence sensor. It is then possible to implement various evaluation methods in the control unit, depending on the operating conditions and customer requirements.

It is, likewise, advantageous if the parameters of the control unit can be set so that different types of operating limitations can be imposed in the event of the misuse of the safety belt.

### BRIEF DESCRIPTION OF THE DRAWING

Additional advantages and details of the invention are described in greater detail below with reference to the exemplary embodiment which is illustrated in greater detail in the accompanying FIGURE.

### DESCRIPTION OF THE PREFERRED EMBODIMENTS

The figure shows a driver's seat 1 of an industrial truck T (of which only the cab is schematically shown) which is equipped with a safety belt 2 in the form of a lap belt 2. The safety belt 2 comprises a belt strap, a coil 3 on which the belt strap is wound up, and a belt buckle which comprises a tab 4 which is fastened to the end of the belt strap, and a socket 5 which is fastened to the driver's seat 1. To close the safety belt 2, the tab 4 is moved in the direction indicated by the arrow 6 around the lap of an operator sitting on the driver's seat 1, and is locked in the socket 5 of the belt buckle.

The invention teaches that the driver's seat 1 is equipped with a conventional belt buckle sensor 7 and a conventional presence sensor 8 that detects the presence of the operator. The two sensors 7 and 8 are connected by signal lines 9, 10 with an electronic control unit 11 in which the signals from the belt buckle sensor 7 and the presence sensor 8 are evaluated. The evaluation is designed to determine, among other things, whether the safety belt 2 is being used properly. One of the objectives of the determination is to verify whether a person sitting on the driver's seat 1 is using the safety belt 2, and whether the safety belt 2 has thereby been placed across the operator's lap. The belt buckle sensor 7 can be realized in the form of a simple electrical switch. For the presence sensor 8, sensors of the prior art suitable for this purpose can be used, for example, sensors that function on the basis of a weight measurement or an inductivity measurement. In addition to the belt buckle sensor 7 and the presence sensor 8, additional information related to the industrial truck, such as the position of a switch lock or the position of an accelerator pedal, for example, can also be taken into consideration as input data by the control unit.

The electronic control unit 11 can have one or more signal outputs 12 with which the result of the evaluation is transmitted. The signal outputs 12 can indicate, for example, whether the safety belt 2 is being used properly or not. If the safety belt 2 is not being used properly, a further differentiation can be made whether the safety belt 2 is simply not being used, or whether deliberate tampering has taken place. Depending on the result of this evaluation, alarm devices that may be connected via the signal outputs 12 can be activated, or certain functions of the industrial truck can be blocked.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
a driver's seat;
a safety belt associated with the driver's seat, wherein the safety belt includes a belt buckle and a belt buckle sensor configured to detect the status of the belt buckle;
a control unit, with the belt buckle sensor operationally connected with the control unit; and
a presence sensor configured to detect the presence of a person in the driver's seat and operationally connected to the control unit.

2. The industrial truck as claimed in claim 1, wherein the control unit is configured such that a status and/or changes in the signals generated by the belt buckle sensor and the presence sensor are continuously measured and evaluated in the control unit.

3. The industrial truck as claimed in claim 2, wherein the control unit generates at least one signal output which reports a proper or improper use of the safety belt as a function of the result of the evaluation of the signals.

4. The industrial truck as claimed in claim 3, wherein when the presence sensor indicates the presence of a person, the signal output then reports the proper use of the safety belt if the belt buckle sensor simultaneously indicates that the belt buckle is closed.

5. The industrial truck as claimed in claim 3, wherein when the presence sensor signals that a person is getting up from the driver's seat, the signal output reports the proper use of the safety belt if, shortly before that, the belt buckle sensor has signaled a release of the belt buckle.

6. The industrial truck as claimed in claim 3, wherein when the presence sensor reports that a person has sat down on the driver's seat, the signal output reports the proper use of the safety belt if the belt buckle sensor simultaneously indicates an open belt buckle.

7. The industrial truck as claimed in claim 2, wherein the control unit is configured such that short-term load reductions detected by the presence sensor are not taken into consideration in the evaluation.

8. The industrial truck as claimed in claim 3, wherein the control unit is configured such that traction operation of the industrial truck is blocked when the signal output reports improper use.

9. The industrial truck as claimed in claim 3, wherein the control unit is configured such that traction operation of the industrial truck is possible only at a reduced maximum speed when the signal output reports improper use.

10. The industrial truck as claimed in claim 3, wherein the control unit is configured such that a continuous alarm signal is generated when the signal output reports the incorrect use of the safety belt.

11. The industrial truck as claimed in claim 2, wherein parameters of the control unit can be set so that different methods can be used to evaluate the signals from the belt buckle sensor and the presence sensor.

12. The industrial truck as claimed in claim 3, wherein the parameters of the control unit can be set so that different types of operating restrictions can be imposed in the event of improper use of the safety belt.

13. The industrial truck as claimed in claim 4, wherein when the presence sensor signals that a person is getting up from the driver's seat, the signal output reports the proper use of the safety belt if, shortly before that, the belt buckle sensor has signaled a release of the belt buckle.

14. The industrial truck as claimed in claim 4, wherein when the presence sensor reports that a person has sat down on the driver's seat, the signal output reports the proper use of the safety belt if the belt buckle sensor simultaneously indicates an open belt buckle.

15. The industrial truck as claimed in claim 8, wherein the improper use is non-attachment of the safety belt.

16. The industrial truck as claimed in claim 9, wherein the improper use is non-attachment of the safety belt.

17. The industrial truck as claimed in claim 10, wherein the incorrect use is improper closing of the belt buckle.
